(19) United States
(12) Patent Application Publication
(10) Pub. No.: US 2020/0114555 A1
(43) Pub. Date: Apr. 16, 2020

(54) METHOD OF MANUFACTURING A MANIFOLD

(71) Applicant: HUSKY INJECTION MOLDING SYSTEMS LTD., BOLTON (CA)

(72) Inventors: Patrice Fabien GAILLARD, Jericho, VT (US); James Osborne PLUMPTON, Enosburg Falls, VT (US); Sami Samuel ARSAN, Mississauga (CA)

(21) Appl. No.: 16/603,221

(22) PCT Filed: Mar. 27, 2018
(86) PCT No.: PCT/US2018/024422

§ 371 Date: Oct. 5, 2019

Related U.S. Application Data
(60) Provisional application No. 62/482,220, filed on Apr. 6, 2017.

(51) Int. Cl. B29C 45/27; B23P 15/00

(52) U.S. Cl. CPC B29C 45/2725; B23P 15/007; B29C 45/2738; B33Y 10/00; B29C 2045/277; B29C 2045/2762; B29C 2045/2722

(57) ABSTRACT

Disclosed is a method of manufacturing a manifold for use in plastic injection molding, the method comprising additive manufacturing a melt distribution structure onto a manifold base plate, wherein the manifold base plate comprises a critical assembly feature.

### TECHNICAL FIELD

The present disclosure relates to molding machines and in particular to a method of manufacturing a manifold for use in plastic injection molding.

### BACKGROUND

Injection molding machines generally include a hopper for receiving resin, a barrel connected to the hopper and a screw that moves within the barrel to impart a force onto the resin to melt and move the resin along the barrel. The melted resin is injected from the barrel into a melt passage apparatus that defines one or more melt passage or melt channel. The melt passage apparatus can include a manifold. The melted resin passes through the melt passage(s) to one or more nozzle. The melted resin is then expelled into a mold cavity through a gate defined in the nozzle. The mold cavity can be formed by clamping two mold plates together.

### BRIEF DESCRIPTION OF THE DRAWINGS

FIG. 1 is a perspective view of a manifold base plate;

FIG. 2 is a perspective view of a manifold base plate with a melt distribution structure;

FIG. 3 is a cut-out view of a section of a manifold base plate and melt distribution structure;

FIG. 4 is a cut-out view of a section of a manifold base plate with a nozzle component and manifold bushing;

FIG. 5 is a perspective view of a manifold base plate with a melt distribution structure;

FIG. 6 is a perspective view of a manifold base plate with a melt distribution structure;

FIG. 8 is a flow chart depicting a method of manufacturing a manifold for using in a molding machine; and

FIG. 7 is a flow chart depicting a method of manufacturing a plurality of manifolds for using in molding machines.

The drawings are not necessarily to scale and may be illustrated by phantom lines, diagrammatic representations and fragmentary views. In certain instances, details that are not necessary for an understanding of the embodiments or that render other details difficult to perceive may have been omitted. Like reference numerals are used in the drawings to identify like elements and features.

### DETAILED DESCRIPTION

Disclosed generally is a method of manufacturing a hot runner manifold for use in plastic injection machine. The hot runner manifold is manufactured partially by typical machining methods and partially by additive manufacturing methods. A manifold base plate is machined out of a block or sheet of material. The machining of the manifold base plate can be performed using subtractive machining methods (i.e. by removing material from the block or sheet to form the manifold base plate). A critical assembly feature can then be machined onto the manifold base plate. The critical assembly feature can be any feature that is critical to the operation of the hot runner manifold or the installation of the hot runner manifold into a molding system or plastic injection machine.

A melt distribution structure can be additively manufactured on the manifold base plate to form the complete hot runner manifold. As a result the manifold can have less material that would be the case in a conventionally manufactured hot runner manifold and can be a fully additively manufactured hot runner manifold. In addition, the shape and design of the various melt channels in the melt distribution structure can be configured in a far greater variety of shapes and designs as would be the case in a conventionally manufactured hot runner manifold.

The machining of the manifold base plate can be performed either before or after the additive manufacturing of the melt distribution structure.

In one aspect, disclosed is a method of manufacturing a manifold for use in plastic injection molding, the method comprising: additive manufacturing a melt distribution structure onto a manifold base plate, wherein the manifold base plate comprises a critical assembly feature.

In another aspect, disclosed is a manifold for use in plastic injection molding, the manifold comprising: a manifold base plate; and a melt distribution structure additive manufactured onto the manifold base plate to form a unitary monolithic structure.

In another aspect, disclosed is a method of manufacturing a plurality of manifolds for use in molding machines, the method comprising: machining a plurality of manifold base plates onto a single sheet; additively manufacturing a melt distribution structure onto at least one of the manifold base plates; and separating the manifold base plate having the melt distribution structure from the sheet.

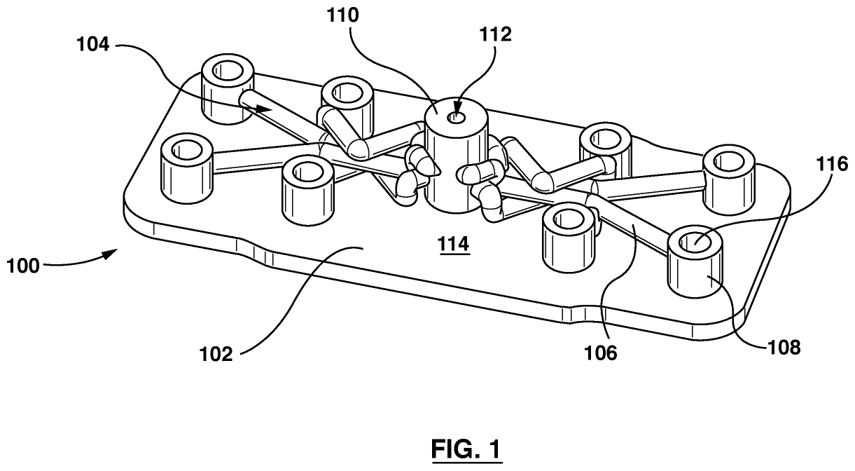

FIG. 1 shows an embodiment of a manifold 100 for a molding machine. The manifold includes a manifold base plate 102 and a melt distribution structure 104.

The manifold base plate 102 can be machined out of a block or piece of steel or metal. The machining of the manifold base plate can be performed using known subtractive manufacturing techniques (i.e. by removing material from the block or piece of steel or metal). The manifold base plate is rectangular in the Figures, but it can be machined into another shape suitable for use in a molding machine.

The melt distribution structure 104 is additive manufactured onto the manifold base plate 102 to form a unitary monolithic structure. After the machining of the manifold base plate 102 is initially completed and before the additive manufacturing occurs, the manifold base plate 102 is inserted into an additive manufacturing machine or, alternatively, an additive manufacturing machine is positioned so that it can operate on the manifold base plate 102.

Alternatively, the melt distribution structure 104 is additive manufactured onto the block or piece of steel or metal before the steel or metal is machined into the manifold base plate 102. In this arrangement the block or piece of steel or metal can be inserted into the additive manufacturing machine (or the additive manufacturing machine is positioned so that it can operate on the block or piece of steel or metal) so that it can operate on the block or piece of steel or metal. After the additive manufacturing is completed, the manifold base plate 102 is machined.

The melt distribution structure 104 includes one or more melt channels 106. The melt channels connect and extend between one or more manifold inlets to one or more manifold outlets. In the embodiment depicted in FIG. 1 there are eight melt channels 106. There can be a different number of melt channels 106 (e.g. one, six, eight, etc.). The melt channels 106 can be additive manufactured according to a predetermined design. For example, the melt channel 106 can be additive manufactured such that the length, shape and diameter of each melt channel 106 is in accordance with certain desired lengths, shapes and diameters.

In the embodiment shown in FIG. 1, the melt channels 106 are cylindrical in shape and are defined by a generally cylindrical inner surface and a generally cylindrical outer surface. In some embodiments, the outer surface can be a different shape (such as defining a rectangle or oval in cross section).

With continued reference to the embodiment in FIG. 1, a sprue 110 is on the manifold base plate 102. The sprue 110 can be additively manufactured onto the manifold base plate 102. In another embodiment, the sprue 110 can be a separate component that is attached (e.g. welded, threaded, bolted) to the manifold 100. The sprue 110 has a sprue inlet 112. The sprue inlet 112 is manufactured so that it can receive melt from an injection nozzle or from another source of melt such as an extruder. The inlets of the melt channels 106 can fluidly interact with the sprue 110 such that inlets are fluidly connected to the sprue inlet 112. For example, the inlets to each melt channel 106 can be defined in the wall or inner surface of the sprue 110, which in turn is fluidly connected to the sprue inlet 112. As such, melt that enters into the sprue inlet 112 can then pass through the inlets into the individual melt channels 106.

The melt distribution structure 104 can include manifold bushing locators 108, such as shown in FIG. 1. The manifold bushing locators 108 are additive manufactured onto the manifold base plate and fluidly interact with the outlets of the melt channels 106. The manifold bushing locators 108 are manufactured to have an interior 116 surrounded by a retaining shape, which in the case of the embodiment of FIG. 1 is a cylindrical shape. In other embodiments, other shapes can be used. The outlets of the melt channels 106 open into the interior 116 of the respective manifold bushing locators 108 so that the melt channels 106 each fluidly communicate with a specific manifold bushing locator 108.

In another embodiment, the manifold busing locators 108 are machined into the manifold base plate before the remainder of the melt distribution structure 104 is additive manufactured onto the manifold base plate 102.

The manifold bushing locators 108 are designed to retain or position manifold bushings. When the manifold is in operation in a molding system, the manifold bushings are retained inside the manifold bushing locators 108. Each manifold bushing locator 108 retains an individual manifold bushing.

In alternative embodiments, the manifold 100 is manufactured without manifold bushing locators 108. For example, the manifold 100 may be used with hot tip nozzles. In such embodiments, the manifold base plate 102 is first machined using conventional subtractive machining and then the melt distribution structure 104 is additively manufactured on top of the manifold base plate 102.

In the embodiment shown in FIG. 1 the manifold distribution structure 104 is additively manufactured onto the injection surface 114 of the manifold base plate 102. The injection surface 114 of the manifold base plate 102 is the surface that faces towards the injection unit or melt extruder during operation of the molding machine or that faces towards the source of the melted resin or it is the surface that first receives the melted resin.

A critical assembly feature 202 can be machined into the manifold base plate 102. The critical assembly feature 202 can be machined before the additive manufacture of the melt distribution structure 104 is performed. Or the critical assembly feature 202 can be machined after the additive manufacture of the melt distribution structure 104 is performed.

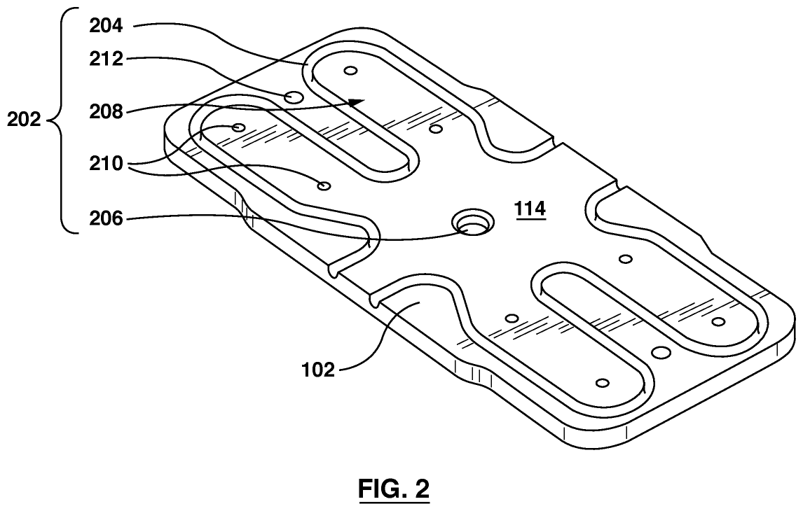

In some embodiments (such as shown in FIG. 2), more than one critical assembly feature 202 is machined into the manifold base plate 102. In other embodiments, only one critical assembly feature 202 is machined into the manifold base plate 102. In either situation, if there are any additional critical assembly features 202 necessary for the operation of the molding machine then they can be attached using other methods (e.g. welding).

The critical assembly feature 202 can be a feature, design, component or other element of the manifold base plate 102 that is critical to the operation of the molding machine with which the manifold 100 is used. For example, the critical assembly feature 202 can be some feature that assists with the functioning of the molding machine or manifold 100 or it can be some feature that assists with the positioning of the manifold 100 in the molding machine.

In an embodiment, the critical assembly feature 202 can be a seal face for sealing high pressure resin at a respective one or more interfaces. For example a face or surface of some part of the manifold base plate 102 can be machined so that it will create a seal against a component or other surface when the manifold is positioned within in the molding machine during operation.

In another embodiment, the critical assembly feature 202 can be a heater installation 204. For example, the heater installation 204 can be an area machined into the manifold base plate 102 that can receive a heater of a specific shape. The heater installation 204 can be shaped to receive or securely hold a heater. The heater can be a cartridge heater or another type of heater suitable for use in a molding machine.

In another embodiment, the critical assembly feature 202 can be an alignment feature 206 for orienting the manifold within a molding machine component. For example, a protrusion can be machined into the manifold base plate 102. The protrusion can be configured so that it aligns with a mating portion of another component associated with the molding machine. In an embodiment the alignment feature 206 is a protrusion that aligns with an aperture in a mold plate so that when the manifold 100 is installed into the machine it is installed with the protrusion aligned with the aperture in the mold plate. In an alternative embodiment, the alignment feature 206 can be a mating section of the manifold base plate 102 which mates with a corresponding protrusion on another component of the molding machine.

FIG. 2 shows an embodiment of a manifold base plate 102 prior to the additive manufacturing of the melt distribution structure 104. The manifold base plate 102 has been machined from a block, sheet or piece of metal using a subtractive manufacturing technique, such as a conventional machining technique. The manifold base plate 102 includes a heater installation 204, an alignment feature 206, a seal face 208, melt holes 210 and a manifold attachment feature 212. Each of these features can be considered a critical assembly feature 202. One or more critical assembly features can be machined into the manifold base plate 102.

The heater installation 204 is machined as a receptacle for holding a specific heater. The heater can be installed into the manifold base plate 102 at a later date.

The alignment feature 206 is a recess extending into the manifold base plate 102 that can be used to align the manifold base plate 102 with a manifold plate or with a platen (e.g. the stationary platen) during installation. A corresponding mating alignment feature (not shown) is associated with the component that is to be aligned with the manifold base plate 102.

The seal face 208 is machined to provide a sealing surface between the manifold base plate 102 and the nozzle against which it will abut during operation of the molding machine.

The melt holes 210 are machined into the manifold base plate 102 to allow melted resin to flow through. For example, the additively manufactured melt distribution structure 104 defines melt channels 106 that lead from a melt inlet to nozzle components. The melt channels 106 pass through the manifold base plate 102 in one or more locations. The melt holes 210 are machined into the manifold base plate 102 and align with the melt channels 106 so that the melted resin flowing in the melt channels 106 can pass through the melt holes 210 and towards the nozzle components.

The manifold attachment feature 212 is a feature machined into the manifold base plate 102 to provide for easy attachment of the manifold 100 to the molding machine. The manifold attachment feature 212 can be threaded bores that allow a screw to secure the manifold 100 (formed from the manifold base plate 102) to the molding machine. Other forms of manifold attachment features 212 can be machined into the manifold base plate 102.

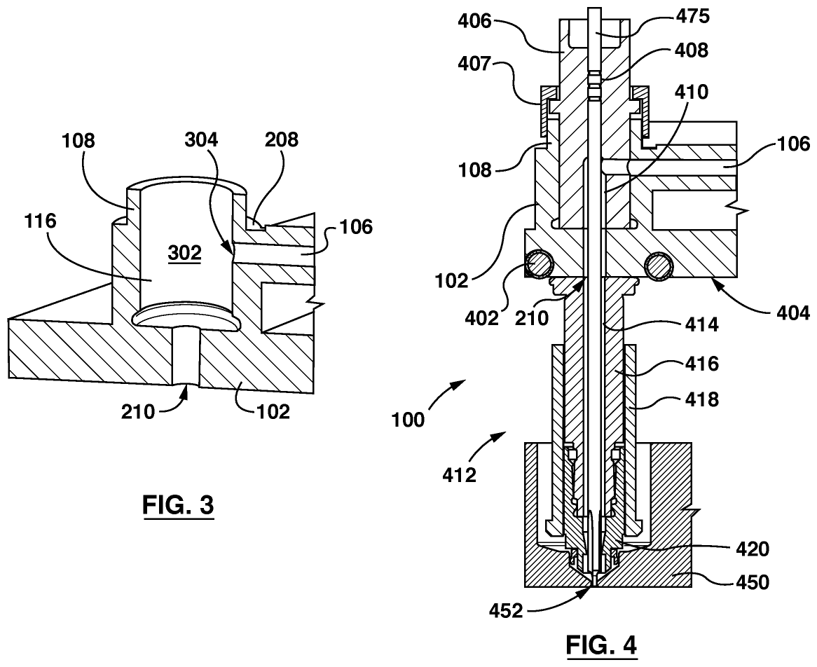

In one or more embodiments, one or more sections of a surface of the additively generated portion of the manifold may be finish machined. Finish machining may provide more precise size, measurements and tolerances. For example, as shown in FIG. 3, the inner surface 302 of the manifold bushing locators 108 can be finish machined in order to smooth out the surface. Similarly, the seal face 208 can be finish machined to provide a smoother surface. In such embodiments, the manifold base plate 102 is machined, then the melt distribution structure 104 and potentially other features is additively manufactured onto the manifold base plate 102, and then one more portions of the additively manufactured sections are finish machined.

The manifold base plate 102 can define a manifold outlet 211. The manifold outlet 211 can be an outlet of the melt hole 210 on a clamp surface 404 of the manifold base plate. The clamp surface 404 of the manifold base plate 102 is the surface of the manifold base plate 102 that faces towards the mold cavity. The melt hole 210 is a critical assembly feature 202 machined into the manifold base plate 102. The manifold outlet 211 fluidly communicates with a melt channel outlet 304. The melt channel outlet 304 is an outlet of the melt channel 106 that connects to and is defined by the inner surface 302 of the manifold bushing locator 108. The manifold bushing locater 108 is fluidly connected to the respective melt hole 210 and thus the respective manifold outlet 211.

FIG. 4 shows a portion of the manifold 100 in operation. A manifold heater 402 is attached to the heater installation 204 on the clamp surface 404 of the manifold base plate 102. The heater installation 204 and thus the manifold heater is located proximal to the melt channel outlet 304 on the clamp surface 404 of the manifold base plate 102. In other embodiments the heater installation 204 and manifold heater 402 can be in different locations on the manifold base plate 102 (such as on the injection surface 114 of the manifold base plate 102).

A manifold bushing 406 is retained in the manifold bushing locator 108. A retaining cap 407 is attached over the manifold bushing 406 to secure it or hold it in the manifold bushing locator 108. The manifold bushing 406 defines a bushing melt channel 410 and a valve stem channel 408. The bushing melt channel 410 fluidly connects with the melt channel 106 on the manifold base plate 102 and with the melt hole 210 so that melt can flow along the melt channel 106 through the bushing melt channel 410 and through the manifold outlet 211. The valve stem channel 408 is designed to accommodate a valve stem 475. The valve stem 475 can be reciprocated (e.g. by an actuator, which is not shown in the figures) within the valve stem channel 408 between an extended and retracted position.

A nozzle component 412 is fluidly associated with the melt channel 106 of the manifold base plate 102. For example, the nozzle component defines a melt passage 414 fluidly connected to one of the one or more manifold outlets 211. In some embodiments, the nozzle component 412 is rigidly fixed to the manifold base plate 102. The nozzle component 412 includes a nozzle housing 416 and a nozzle tip 420. A nozzle heater 418 is attached the exterior of the nozzle housing 416. The nozzle tip 420 is attached to an end of the nozzle housing 416 that is distal to the manifold base plate 102. The nozzle tip 420 can be screwed on or pressure fitted against the nozzle housing 416, for example. In other embodiments a separate retainer can secure the nozzle tip 420 to the nozzle housing 416. In other embodiments, the nozzle tip 420 and nozzle housing 416 are fabricated out of the same material.

The nozzle component 412 can be slidingly attached or slidingly sealed against the clamp surface 404 (or seal surface) of the manifold base plate 102. A mold plate 450 is shown engaging with the nozzle tip 420. The mold plate 450 defines a mold gate 452 leading to a mold cavity, which defines the part that will be molded.

In another embodiment (not depicted by the Figures), the nozzle component 412 is additively manufactured onto the manifold base plate 102. For example, the nozzle component 412 can be additively manufactured to the clamp surface 404 of the manifold base plate 102. The nozzle component 412 can include a nozzle housing 416 and defines a melt passage 414 fluidly connected to one of the one or more manifold outlets 210. In other embodiments, a portion of the nozzle component 412 is additively manufactured onto the machine base plate 102.

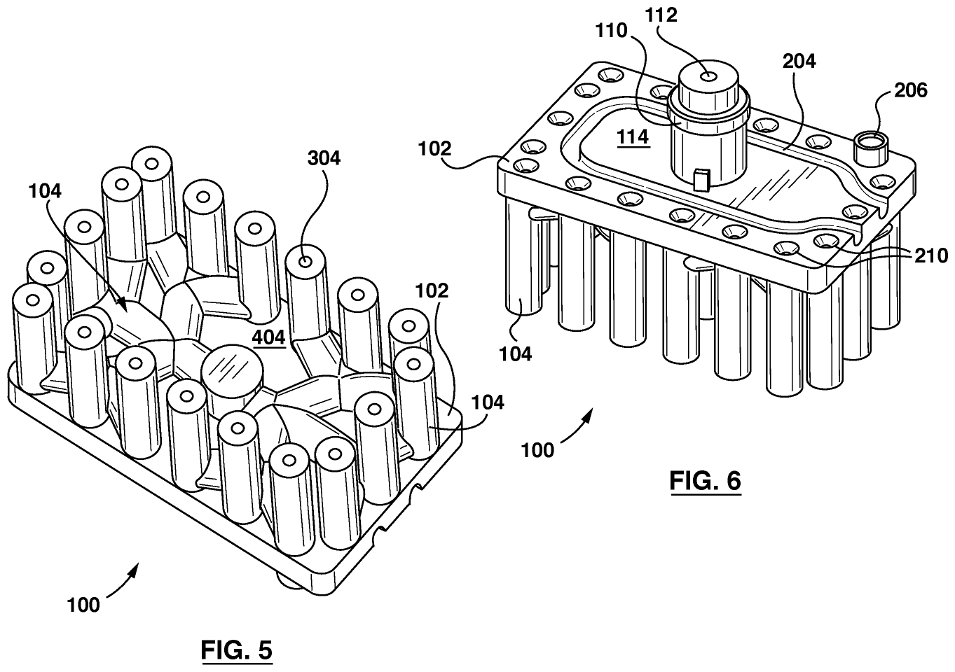

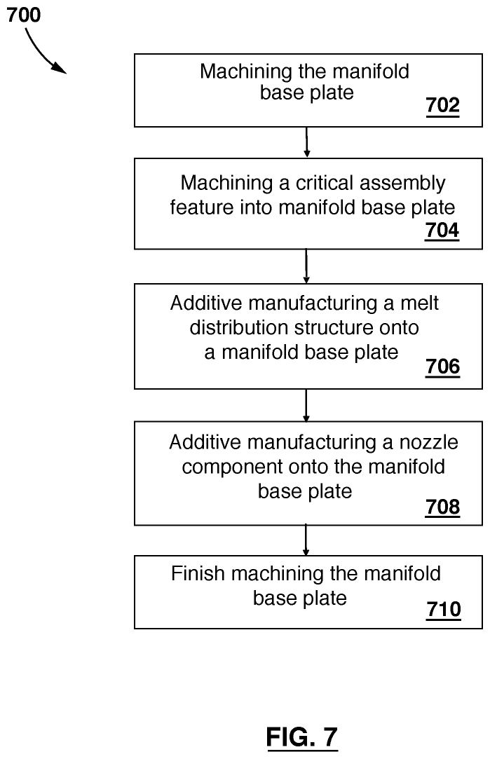

In one or more embodiments, the melt distribution structure 104 is additively manufactured onto the clamp surface 404 of the manifold base plate 102. FIGS. 5 and 6 show an exemplary embodiment of a manifold base plate 102 with the melt distribution structure 104 additively manufactured onto the clamp surface 404 of the manifold base plate 102.

In the embodiment shown in FIGS. 5 and 6, the sprue 110 for the injection nozzle is on the injection surface 114 of the manifold base plate 102. The sprue 110 defines a sprue inlet 112 that fluidly connects to the injection unit (not depicted in the Figures). The sprue 110 can be machined into the manifold base plate 102, for example. Alternatively, the sprue 110 can be a separate component that is connected to the manifold base plate 102.

In the embodiment shown in FIGS. 5 and 6, the heater installation 204 is manufactured into the manifold base plate 102 and an alignment feature 206 is manufactured into the base plate. The alignment component is approximately at a corner on the injection surface 114 of the manifold base plate 102. The alignment feature 206 can interact with another part (e.g. a mating part) of the molding machine during installation of the manifold 100 or during operation of the molding machine to ensure that the manifold 100 is in an appropriate orientation or position.

The heater installation 204 and alignment feature 206 are examples of critical assembly features required in order for the manifold 100 to operate as intended in the molding machine.

With continued reference to FIGS. 5 and 6, the melt distribution structure 104 defines the melt channels on the clamp surface 404 of the manifold base plate 102. The melt channels 106 form a fluid connection to the sprue inlet 112 through a machine aperture in the manifold base plate 102. In the embodiment shown in FIGS. 5 and 6 the machined aperture is approximately in the center of the manifold base plate 102.

The melt distribution structure 104 defines a number of melt channel outlets 304. Each melt channel outlet 304 fluidly connects to a portion of the melt channel 106. For example, the melt distribution structure 104 defines a plurality of melt channels 106 branching out from the injection bushing with each of the plurality of melt channels 106 leading to a melt channel outlet 304. In one or more embodiments, the melt channel outlets 304 each lead to a separate nozzle component 412 (not shown) The nozzle component 412 can be a separate component that connects to the melt channel outlet or the nozzle component 412 can be additively manufactured onto the end (so as to form part of) of the melt distribution structure 104.

The term “clamp surface” 404 is used to identify the surface of the manifold base plate 102 that is designed to face in the direction of the cavity of the mold in operation. The term “injection surface” 114 is used to identify the surface of the manifold base plate 102 that is designed to face the injection nozzle during operation.

FIG. 7 depicts a method 700 of manufacturing a manifold 100 for a molding machine. The manifold 100 can be the manifold 100 described with respect to the embodiments shown in FIGS. 1 to 6 for example.

At 702 the manifold base plate 102 is machined. For example, the manifold base plate 102 can be machined using known subtractive machining techniques. A block of metal can be machined so that it is shaped into the desired dimensions for the manifold base plate 102. Other components or features of the manifold 100 can be machined directly into the manifold base plate 102, such as rounded corners, apertures to accommodate various machine parts (such as valve stems 475 or melt channels).

At 704 a critical assembly feature 202 is machined into the manifold base plate 102. In some embodiments, more than one critical assembly feature 202 is machined into the manifold base plate 102.

The critical assembly feature 202 can include one or more seal faces 208. The one or more seal faces are for sealing high pressure resin at a respective one or more interfaces.

The critical assembly feature 202 can include one or more heater installations 204. The one or more heater installations 204 are for retaining a heater to provide heat to the manifold 100. The heater installations 204 can also be designed to retain a heater to provide heat to the nozzle component 412 or to the melted resin inside of the melt channels 106.

The critical assembly feature 202 can include one or more alignment features 206. The one or more alignment features 206 is for orienting the manifold within a molding machine component. For example, an alignment feature 206 on the manifold 100 can interact with a mold plate or with another component of the molding machine so as to prevent unwanted movement of the manifold 100 within the molding machine during operation. In some embodiments, the component can be one of a mold and a manifold plate. By way of further example, the alignment feature 206 on the manifold 100 can interact with a component of the molding machine to guide the installation of the manifold 100 into a working orientation and position within the molding machine.

The critical assembly feature 202 can include one or more attachment feature 212. The one or more attachment feature 212 is for mounting the manifold 100 to a molding machine component. For example, the attachment feature 212 can be designed to receiving a screw, bolt, or other attachment component so at to allow the attachment of the manifold 100 within the molding machine.

At 706 a melt distribution structure 104 is additive manufactured onto the manifold base plate 102. In an embodiment, the melt distribution structure comprises a melt distribution circuit having one or more melt channels 106 connecting one or more manifold inlets to one or more manifold outlets 211.

In some embodiments the melt distribution structure 104 is additive manufactured onto the manifold base plate 102 (at 706) before the manifold base plate 102 is machined.

Optionally, at 708, a nozzle component 412 is additive manufactured onto the manifold base plate 102. In some embodiments, the nozzle component 412 defines a melt passage 414 fluidly connected one of the melt channels 106.

In an embodiment, the nozzle component 412 includes a nozzle housing 416.

Optionally, at 710, the manifold base plate 102 is finish machined. In one embodiment, the manifold base plate 102 is finish machined after melt distribution structure 104 is additive manufactured. In another embodiment, the manifold base plate 102 is finish machined prior to additive manufacturing the melt distribution structure 104.

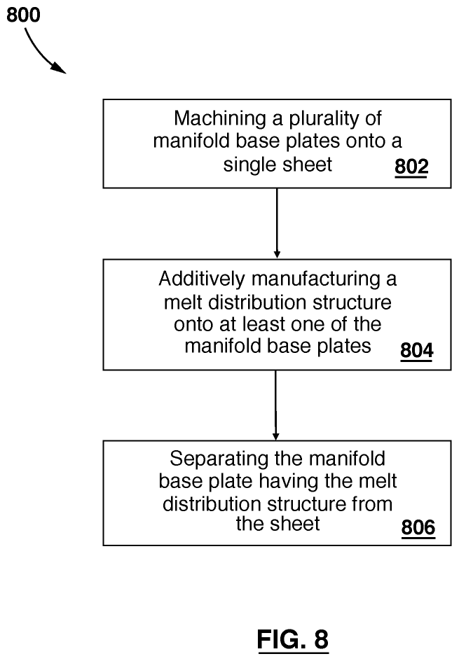

FIG. 8 depicts a method 800 of manufacturing a plurality of manifolds 100 for use in molding machines.

At 802 a plurality of manifold base plates 102 are machined onto a single sheet. The sheet can be a sheet of metal. For example, a sheet or block of metal is machined using subtractive machining techniques (i.e. by removing material from the metal) in order to form more than one manifold base plates 102 into or onto the sheet. Each manifold base plate 102 can still be connected along its edges to another manifold base plate 102 so that multiple manifold base plate 102 are formed in the single sheet. For example, when each manifold base plate 102 is machined onto the metal sheet the edges of the manifold base plates 102 are not separated so that there is one metal sheet with the surfaces (e.g. the clamp surface 404 and injection surface 114) of each manifold base plate 102 machined into it.

At 804 a melt distribution structure 104 is additively manufactured onto at least one of the manifold base plates 102. For example, the melt distribution structure 102 can be additively manufactured onto one of the manifold base plates 102 on the sheet of manifold base plates 102. In another embodiment, melt distribution structures 104 are additively manufactured onto each of the manifold base plates 102 on or connected by the sheet.

At 806 the manifold base plate 102 having the melt distribution structure 104 is separated from the sheet. For example, the manifold base plate 102 that has the melt distribution structure 104 additively manufactured on top of it can be cut out from the remainder of the metal sheet.

In another embodiments, each manifold base plate 102 on the sheet of metal is cut out or separated. For example, water jet cutting can be used to cut out or separate each manifold base plate 102 from the others. The edges of the cut out manifold base plates 102 can be further machined. In other examples, laser cutting, milling, sawing or other similar techniques can be used.

A critical assembly feature 202 can be machined onto the manifold base plates 102 either before or after the manifold base plates 102 are separated. The critical assembly feature 202 can be one or more seal faces 208 for sealing high pressure resin at a respective one or more interfaces. The critical assembly features 202 can be one or more heater installations 204. The one or more heater installations are for retaining a heater to that provides heat to the manifold 100. The critical assembly feature can be one or more alignment features 206 for orienting the manifold 100 within a molding machine component. The critical assembly feature 202 can be one or more attachment feature for mounting the manifold 100 to a molding machine component. The molding machine component can be one of a mold and a manifold plate.

One or more of the manifold base plates 102 can be finish machined. For example, the manifold base plates 102 can be finish machined after the melt distribution structure 104 is additively manufactured. By way of further example, the manifold base plate(s) 102 are finish machined prior to additive manufacturing the melt distribution structure 104. The melt distribution structure 104 can include a melt distribution circuit having one or more melt channels 106 connecting one or more manifold inlets to one or more manifold outlets. The melt distribution circuit can be defined as the collection of melt channels 106 on the manifold 100.

A nozzle component 412 can be additive manufactured onto the one or more manifold base plate 102. The nozzle component 412 can include a nozzle housing 416. The nozzle component 412 defines a melt passage fluidly connected to the melt channels 106.

By way of non-limiting example only, additive manufacturing can include any suitable type of additive manufacturing such as cold spay, laser deposition, direct metal laser sintering, ultrasonic additive manufacturing, etc.

Other non-limiting embodiments, modifications and equivalents will be evident to one of ordinary skill in the art in view of the present disclosure.

This disclosure has presented one or more non-limiting exemplary embodiments. It will be clear to those skilled in the art that modifications and variations can be made to the disclosed non-limiting embodiments without departing from the intended scope of this disclosure. The described non-limiting embodiments ought to be considered to be merely illustrative of some of the features or elements of this disclosure as a whole. Other beneficial results can be realized by applying the non-limiting embodiments in a different manner or modifying them in ways known to those familiar with the art. Certain features or sub-features of one embodiment may be combined with certain features or sub-features of another embodiment to arrive at a combination of features not specifically described above but still within the intended scope of the disclosure. Any such suitable and workable combination of features would be known to persons skilled in the relevant art after reviewing the present disclosure.

What is claimed is:

1. A method of manufacturing a manifold for use in plastic injection molding, the method comprising:
additive manufacturing a melt distribution structure onto a manifold base plate, wherein the manifold base plate comprises a critical assembly feature.

2. The method of claim 1 further comprising machining the manifold base plate.

3. The method of claim 2 further comprising machining the critical assembly feature into the manifold base plate.

4. The method of claim 3 wherein the critical assembly feature comprises:
one or more seal faces for sealing high pressure resin at a respective one or more interfaces.

5. The method of claim 3 wherein the critical assembly feature comprises:
one or more heater installations.

6. The method of claim 3 wherein the critical assembly feature comprises:
one or more alignment features for orienting the manifold within a molding machine component.

7. The method of claim 3 wherein the critical assembly feature comprises:
one or more attachment feature for mounting the manifold to a molding machine component.

8. The method of claim 4 wherein the molding machine component is one of a mold and a manifold plate.

9. The method of claim 8 wherein the manifold base plate is finish machined.

10. The method of claim 9 wherein the manifold base plate is finish machined prior to additive manufacturing the melt distribution structure.

11. The method of claim 10 wherein the melt distribution structure comprises:
a melt distribution circuit having one or more melt channels connecting one or more manifold inlets to one or more manifold outlets.

12. The method of claim 11 further comprising additive manufacturing a nozzle component onto the manifold base plate.

13. The method of claim 12, wherein the nozzle component comprises a nozzle housing.

14. The method of claim 13, wherein the nozzle component defines a melt passage fluidly connected to one of the one or more melt channels.

15. A manifold for use in plastic injection molding, the manifold comprising:
a manifold base plate; and
a melt distribution structure additive manufactured onto the manifold base plate to form a unitary monolithic structure.

16. The manifold of claim 15 further comprising a critical assembly feature machined into the manifold base plate.

17. The manifold of claim 16, wherein the melt distribution structure comprises one or more melt channels connecting one or more manifold inlets to one or more manifold outlets.

18. The manifold of claim 17 further comprising a nozzle component additively manufactured onto the manifold base plate.

19. (canceled)

20. The manifold of claim 19, wherein the nozzle component defines a melt passage fluidly connected to one of the one or more manifold outlets.

21. A method of manufacturing a plurality of manifolds for use in molding machines, the method comprising:
machining a plurality of manifold base plates onto a single sheet;
additively manufacturing a melt distribution structure onto at least one of the manifold base plates; and
separating the manifold base plate having the melt distribution structure from the sheet.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
